(19) United States
(12) Patent Application Publication
(10) Pub. No.: US 2004/0004029 A1
(43) Pub. Date: Jan. 8, 2004

(54) Monolith sorbent for sulfur removal

(76) Inventors: Gyanesh P. Khare, Kingwood, TX (US); Edward L. Sughrue, Bartlesville, OK (US)

Correspondence Address: RICHMOND, HITCHCOCK, FISH & DOLLAR, P.O. Box 2443, Bartlesville, OK, 74005, US

(21) Appl. No.: 10/190,914

(22) Filed: Jul. 8, 2002

(51) Int. Cl. C10G 25/00; B01J 20/00

(52) U.S. Cl. 208/208 R; 208/299; 208/300; 208/305; 502/400

(57) ABSTRACT

A monolith sorbent which defines a plurality of open-ended channels and comprises a reduced-valence promoter metal component and zinc oxide can be employed to desulfurize sulfur-containing fluids such as cracked-gasoline or diesel fuel.

### BACKGROUND OF THE INVENTION

This invention relates to a monolith sorbent composition, a process of making a monolith sorbent composition, and a process of using a monolith sorbent composition for the removal of sulfur from a sulfur-containing fluid.

Hydrocarbon-containing fluids such as gasoline and diesel fuels typically contain a quantity of sulfur. High levels of sulfur in such automotive fuels is undesirable because oxides of sulfur present in automotive exhaust may irreversibly poison noble metal catalysts employed in automobile catalytic converters. Emissions from such poisoned catalytic converters may contain high levels of non-combusted hydrocarbons, oxides of nitrogen, and/or carbon monoxide, which, when catalyzed by sunlight, form ground level ozone, more commonly referred to as smog.

Much of the sulfur present in the final blend of most gasolines originates from a gasoline blending component commonly known as “cracked-gasoline.” Thus, reduction of sulfur levels in cracked-gasoline will inherently serve to reduce sulfur levels in most gasolines, such as, automobile gasolines, racing gasolines, aviation gasolines, boat gasolines, and the like.

Many conventional processes exist for removing sulfur from cracked-gasoline. However, most conventional sulfur removal processes, such as hydrodesulfurization, tend to saturate olefins and aromatics in the cracked-gasoline and thereby reduce its octane number (both research and motor octane number). Thus, there is a need for a process wherein desulfurization of cracked-gasoline is achieved while the octane number is maintained.

In addition to the need for removing sulfur from cracked-gasoline, there is also a need to reduce the sulfur content in diesel fuel. In removing sulfur from diesel fuel by hydrodesulfurization, the cetane is improved but there is a large cost in hydrogen consumption. Such hydrogen is consumed by both hydrodesulfurization and aromatic hydrogenation reactions. Thus, there is a need for a process wherein desulfurization of diesel fuel is achieved without significant consumption of hydrogen so as to provide a more economical desulfurization process.

Traditionally, sorbent compositions used in processes for removing sulfur from sulfur-containing fluids, such as cracked-gasoline and diesel fuel, have been agglomerates packed in fixed bed reactors. Because fluidized bed reactors have advantages over fixed bed reactors, such as better heat transfer, better mass transfer, and better pressure drop, sulfur-containing fluids are sometimes processed in fluidized bed reactors. Fluidized bed reactors generally use reactants (e.g., catalysts or sorbent compositions) that are in the form of relatively small particulates. The size of these particulates is generally in a range of from about 1 micron to about 10 millimeters.

Although fluidized bed reactors provide numerous advantages (e.g., improved heat transfer, mass transfer, and pressure drop) over packed fixed bed reactors, fluidized bed systems can be expensive to design, construct, and operate due to their complexity. Another disadvantage of fluidized bed reactors is the requirement that the feed to the reactor be in a gaseous state. This gaseous feed requirement can make it difficult to employ fluidized bed reactors for processing relatively high boiling range hydrocarbons, such as diesel. A further disadvantage of fluidized bed systems is attrition of the solid reactants (i.e., catalysts or sorbents) in the reactor caused by the continual turbulent motion and physical contacting of the reactants. Such attrition of the reactants can shorten the life of the reactants and can cause problems in separating the fine, attrited reactant particles from the reactor effluent. Consequently, finding a system which provides the advantages (i.e., improved heat transfer, mass transfer, and pressure drop) of fluidized bed reactors without the drawbacks (i.e., expense, feed limitations, and reactant attrition) of fluidized bed reactors would be a significant contribution to the art and the economy.

It is known that monolith fixed bed reactors can provide improved heat transfer, mass transfer, and pressure drop versus conventional packed bed reactors. These improvements are due to the implementation of multicellular, honeycomb-like monolith reactants (i.e., catalysts or sorbents) which have a plurality of open-ended channels extending therethrough. The feed to the monolithic reactors is passed through these channels wherein it is contacted with the catalytic or sorbent material of the channel walls. Although the process advantages of monolith reactors are known in the art, no one has been able to design a suitable monolith sorbent for removing sulfur from sulfur-containing fluids which exploits these process advantages. Consequently, finding a monolith sorbent composition which adequately removes sulfur from sulfur-containing fluids, such as cracked gasoline or diesel fuel, without significant octane loss or hydrogen consumption would be a significant contribution to the art and the economy.

### SUMMARY OF THE INVENTION

Accordingly, it is an object of the present invention to provide a novel monolith sorbent composition which is suitable for removing sulfur from sulfur-containing fluids, such as cracked-gasoline and diesel fuels.

A further object of this invention is to provide a novel process for making a monolith sorbent composition.

Another object of this invention is to provide a process for the removal of sulfur from sulfur-containing fluid streams which minimizes saturation of olefins and aromatics therein.

A still further object of this invention is to provide a process for the removal of sulfur from sulfur-containing fluid streams which minimizes hydrogen consumption.

It should be noted that the above-listed objects need not all be accomplished by the invention claimed herein and other objects and advantages of this invention will be apparent from the following description of the preferred embodiments and appended claims.

Accordingly, in one embodiment of the present invention, a monolith sorbent is provided. The monolith sorbent comprises a multicellular body which defines a plurality of coextensive open-ended channels and comprises a reduced-valence promoter metal component and zinc oxide.

In another embodiment of the present invention, a process for making a monolith sorbent is provided. The process comprises the steps of: (a) providing a multicellular substrate defining a plurality of coextensive open-ended substrate channels; (b) coating the substrate with a washcoat slurry comprising zinc oxide to provide a washcoated substrate; (c) incorporating a promoter metal with the washcoated substrate to provide a promoted washcoated substrate; (d) calcining the promoted washcoated substrate to provide an unreduced monolith sorbent; and (e) reducing the unreduced promoted sorbent to thereby provide a reduced monolith sorbent comprising a reduced-valence promoter metal component and zinc oxide.

In a further embodiment of the present invention, there is provided a desulfurization process comprising the steps of: (a) passing a sulfur-containing fluid through a monolith sorbent comprising a reduced-volume promoter metal component and zinc oxide under desulfurization conditions sufficient to convert at least a portion of the zinc oxide to zinc sulfide, thereby providing a sulfided sorbent; (b) passing an oxygen-containing regeneration stream through the monolith sorbent under regeneration conditions sufficient to convert at least a portion of the zinc sulfide to zinc oxide, thereby providing an unreduced monolith sorbent comprising an unreduced promoter metal component; and (c) passing a hydrogen-containing reducing stream through the unreduced monolith sorbent under activation conditions sufficient to reduce the valence of the unreduced promoter metal component, thereby providing a reduced monolith sorbent comprising a reduced-valence promoter metal component and zinc oxide.

### DETAILED DESCRIPTION OF THE PREFERRED EMBODIMENTS

In accordance with a first embodiment of the present invention, a novel process for making a sorbent composition is provided. The process generally comprises the steps of: (a) providing a multicellular monolith substrate which defines a plurality of coextensive open-ended channels; (b) coating the substrate with a washcoat slurry comprising a zinc source, a carrier, and a liquid to provide a washcoated substrate; (c) calcining the washcoated substrate to provide a calcined washcoated substrate; (d) incorporating a promoter metal with the calcined washcoated substrate to provide a promoted washcoated substrate; (e) calcining the promoted washcoated substrate to provide an unreduced promoted monolith sorbent comprising an unreduced promoter metal component; and (f) reducing the unreduced promoted monolith sorbent to thereby provide a reduced monolith sorbent comprising a reduced-valence promoter metal component and zinc oxide.

The multicellular monolith substrate employed in the above-described process can be any material which can be formed into a rigid monolithic structure defining a plurality of substantially parallel channels extending therethrough. The multicellular monolith substrate preferably has a generally honeycomb-like configuration and includes a plurality of thin walls defining the channels. A cross-section of the substrate, taken perpendicular to the direction of extension of the channels, reveals the cell density (i.e., number of channels per square inch) of the substrate. Preferably, the substrate has a cell density in the range of from about 10 to about 1500 channels per square inch, more preferably in the range of from about 50 to about 500 channels per square inch, and most preferably in the range of 80 to 200 channels per square inch.

The multicellular monolith substrate is preferably made of an inert ceramic material such as, for example, cordierite, mullite, alumina, or zircon. More preferably, the substrate is formed of cordierite comprising silica (SiO₂), alumina (Al₂O₃), and magnesia (MgO). The multicellular substrate preferably comprises 11 to 17 weight percent MgO, 33 to 41 weight percent Al₂O₃, and 46 to 53 weight percent SiO₂. The multicellular substrate can have the physical structure, properties, and composition of the substrate described in U.S. Pat. No. 3,885,977, the entire disclosure of which is incorporated herein by reference.

Prior to coating the substrate with a washcoat, the washcoat slurry is made by admixing the washcoat slurry components. The washcoat slurry generally includes solid washcoat components and liquid washcoat components. Preferably, the weight ratio of solid washcoat components to liquid washcoat components in the washcoat slurry is in the range of from about 0.2:1 to about 10: 1, more preferably in the range of from about 0.5:1 to about 2:1, and most preferably in the range of from 0.75:1 to 1.5:1. The solid and liquid components of the washcoat slurry can be combined and mixed by any suitable method or manner which provides for the intimate mixing of such components to thereby provide a substantially homogenous mixture of the washcoat slurry components. Any suitable means for mixing the washcoat slurry components can be used to achieve the desired dispersion of such components. Examples of suitable mixing means include, but are not limited to, mixing tumblers, stationary shells, or troughs. It is presently preferred to use a Muller mixer in the mixing of the washcoat slurry components.

The solid components of the washcoat slurry preferably include a zinc source and a carrier, while the liquid components of the washcoat preferably include a solvent and a dispersant.

The zinc source of the washcoat slurry can be any zinc-containing compound. Preferably, the zinc source is in the form of zinc oxide or one or more zinc compounds that are convertible to zinc oxide. Most preferably, the zinc source is in the form of a powdered zinc oxide. The zinc source, preferably powdered zinc oxide, will generally be present in the washcoat slurry in an amount in the range of from about 20 to about 90 weight percent based on a total weight of the solid washcoat components, more preferably in the range of from about 40 to about 80 weight percent, and most preferably in the range of from 50 to 70 weight percent.

The carrier of the washcoat slurry can be any suitable organic and/or inorganic carrier. Examples of suitable organic carriers include, but are not limited to, activated carbon, coke, charcoal, and carbon-containing molecular sieves. Examples of suitable inorganic carriers include, but are not limited to, silica, silica gel, alumina, diatomaceous earth, perlite, expanded perlite, kieselguhr, silica-alumina, titania, zirconia, zinc aluminate, zinc titanate, zinc silicate, magnesium aluminate, magnesium titanate, synthetic zeolites, and natural zeolites. The carrier employed in the washcoat slurry preferably includes both an aluminum source (e.g., alumina) and a silicon source (e.g., silica).

The aluminum source of the washcoat slurry can be any aluminum-containing compound. The aluminum source can be any suitable commercially available alumina material including, but not limited to, colloidal alumina solutions, hydrated aluminas, peptized aluminas, and, generally, those alumina compounds produced by the dehydration of alumina hydrates. The preferred alumina source is a hydrated alumina such as, for example, boehmite or pseudoboehmite. The aluminum source, preferably a hydrated alumina, will generally be present in the washcoat slurry in an amount such that the weight ratio of the zinc source to the aluminum source is in the range of from about 0.5:1 to about 20: 1, more preferably in the range of from about 1:1 to about 10:1, and most preferably in the range of from 3:1 to 7:1.

The silicon source of the washcoat slurry can be any silicon-containing compound. The silicon source can be any suitable commercially available silica such as, for example, diatomite, perlite, expanded perlite, silicalite, silica colloid, flame-hydrolyzed silica, hydrolyzed silica, silica gel, and precipitated silica. Preferably, diatomite is employed as the silicon source. The silicon source, preferably diatomite, should generally be present in the washcoat slurry in an amount such that the weight ratio of the zinc source to the silicon source is in the range from about 0.5:1 to about 20:1, more preferably in the range of from about 1:1 to about 10:1, and most preferably in the range of 2:1 to 4:1.

The solvent of the washcoat slurry can be any liquid added to the washcoat slurry to help form a washcoat slurry having an optimum consistency for coating the substrate. The most preferred solvent is distilled water. The solvent, preferably distilled water, should be present in the washcoat slurry in an amount such that the solvent makes up in the range of from about 50 to about 100 weight percent of the liquid washcoat components, and most preferably in the range of from 95 to 99 weight percent of the liquid washcoat components.

When a dispersant is employed in the washcoat slurry, the dispersant can be any substance, preferably a liquid, added to the washcoat slurry to help disperse the solid components in the washcoat slurry and help to provide a more flowable washcoat slurry. Suitable dispersants include inorganic acids, inorganic bases, organic acids, organic bases, poly (acrylic acid), salts of poly (acrylic acid), poly (methacrylic acid), salts of poly (methacrylic acid), copolymers of poly (acrylic acid), salts of copolymers of poly (acrylic acid), copolymers of poly (methacrylic acid), salts of copolymers of poly (methacrylic acid), poly (ethylene imine), polyvinylpyrrolidone, polyacrylamide, lignosulfonates, poly (ethylene oxide), adducts of ethylene oxide, adducts of propylene oxide, polycarboxylates, salts of polycarboxylates, maphthalene sulfonates, sulfosuccinates, polyphosphates, sodium silicates, phosphate esters, and mixtures thereof. Most preferably, the dispersant is ammonium polyacrylate. The dispersant should be present in the washcoat slurry in an amount such that the dispersant makes up in the range of from about 0.1 to about 20 weight percent of the liquid washcoat components, and most preferably in the range of from about 1 to about 5 weight percent of the liquid washcoat components.

After the solid and liquid components of the washcoat slurry are suitably mixed, the substrate is coated with the washcoat slurry by any suitable manner or method which provides a thin layer of the washcoat slurry on the substrate. A preferred method of coating the substrate is to dip the substrate into a volume of the washcoat slurry to thereby provide a washcoated substrate. It may be necessary to repeatedly dip the substrate in the washcoat slurry in order to obtain a washcoat of desired thickness.

After coating, the washcoated substrate is preferably dried and calcined. Any drying method(s) known to one skilled in the art such as, for example, air drying, heat drying, vacuum drying, and the like and combinations thereof, can be used. Preferably, the washcoated substrate is dried at a temperature in the range of from about 180° F. to about 290° F., more preferably in the range of from 200° F. to 270° F. The pressure employed during drying of the washcoated substrate can be in the range of from about atmospheric (i.e., 14.7 pounds per square inch absolute) to about 150 pounds per square inch absolute (psia), more preferably in the range of from about atmospheric to about 100 psia, and most preferably about atmospheric, so long as the desired temperature can be maintained. Any suitable period for drying the washcoated substrate can be employed. Preferably, the drying of the washcoated substrate takes place during a time period in the range of from about 0.5 hour to about 60 hours, more preferably in the range of from 1 hours to 20 hours.

The calcining of the dried washcoated substrate can be performed at a calcination temperature in the range of from about 400° F. to about 1800° F., more preferably in the range of from about 600° F. to about 1600° F., and most preferably in the range of from 800° F. to 1500° F. The calcination pressure is preferably in the range of from about 7 psia to about 750 psia, more preferably in the range of from about 7 psia to about 450 psia, and most preferably in the range of from 7 psia to 150 psia. The time period for the calcination of the dried washcoated substrate is generally in the range of from about 0.1 hour to about 60 hours, more preferably in the range of from about 0.5 hours to about 20 hours, and most preferably in the range of from 1 hours to 15 hours.

During calcination of the washcoated substrate, at least a portion of the zinc source and at least of portion of the aluminum source contained in the washcoat chemically combine to form zinc aluminate (ZnAl₂O₄). The calcined washcoat of the calcined washcoated substrate preferably comprise zinc aluminate in an amount in the range of from about 2 to about 40 weight percent based on the total weight of the calcined washcoat of the calcined washcoated substrate, more preferably in the range of from about 5 to about 30 weight percent, and most preferably in the range of from 10 to 20 weight percent. The calcined washcoat of the calcined washcoated substrate preferably comprise zinc oxide in an amount in the range of from about 20 to about 95 weight percent based on the total weight of the washcoat, more preferably in the range of from about 40 to about 85 weight percent, and most preferably in the range of from 60 to 80 weight percent.

The resulting calcined washcoated substrate can then be contacted with a promoter metal source to thereby incorporate the promoter metal with the calcined washcoated substrate. The promoter metal can be at least one metal selected from the group consisting of nickel, cobalt, iron, manganese, tungsten, silver, gold, copper, platinum, zinc, tin, ruthenium, molybdenum, antimony, vanadium, iridium, chromium, palladium, and rhodium. Most preferably, the promoter metal is nickel. The promoter metal may be incorporated on, in, or with the calcined washcoated substrate by any suitable means or method known in the art such as, for example, impregnating, soaking, spraying, and combinations thereof. The preferred method of incorporating the promoter metal with the calcined washcoated substrate is impregnating using incipient wetness impregnation techniques. A preferred impregnation method employs an impregnation solution comprising the desired concentration of the promoter metal so as to ultimately provide a promoted monolithic sorbent comprising the desired quantity of the promoter metal. The impregnation solution can be an aqueous solution formed by dissolving the promoter metal source in a solvent, preferably water. It is acceptable to use somewhat of an acidic solution to aid in the dissolution of the promoter metal source. It is most preferred for the calcined washcoated substrate to be impregnated with the promoter metal by using a solution containing nickel nitrate hexahydrate dissolved in water.

Generally, the amount of the promoter metal incorporated, preferably impregnated, onto, into or with the calcined washcoated substrate, is an amount which provides a promoted washcoated substrate comprising the promoter metal in an amount in the range of from about 1 to about 60 weight percent promoter metal based on the total weight of the washcoat of the promoted washcoated substrate, preferably an amount in the range of from about 5 to about 50 weight percent promoter metal, and most preferably in an amount in the range of from 10 to 40 weight percent promoter metal. It may be necessary to employ one or more incorporation steps in order to incorporate the desired quantity of the promoter metal with the calcined washcoated substrate. If so, such additional incorporation(s) are performed in substantially the same manner as described above.

Once the promoter metal has been incorporated on, in, or with the calcined washcoated substrate, the promoted washcoated substrate is then dried and calcined to form an unreduced monolith sorbent. The drying and calcining of the promoted washcoated substrate can be accomplished by any suitable method(s) known in the art. Preferably, the drying and calcining of the promoted washcoated substrate is performed in substantially the same manner and under substantially the same conditions as previously described with reference to the drying and calcining of the unpromoted washcoated substrate.

When the promoted washcoated substrate is calcined, at least a portion of the promoter metal and at least a portion of the zinc oxide present in the washcoat chemically combine to form an unreduced promoter metal component comprising, consisting of, or consisting essentially of a substitutional solid metal oxide solution characterized by the formula: M_{X}Zn_{Y}O, wherein M is the promoter metal and X and Y are each numerical values in the range of from 0.01 to about 0.99. In the above formula, it is preferred for X to be in the range of from about 0.5 to about 0.9 and most preferably from 0.6 to 0.8. It is further preferred for Y to be in the range of from about 0.1 to about 0.5, and most preferably from 0.2 to 0.4. Preferably, Y is equal to (1-X). The washcoat of the unreduced monolith sorbent preferably comprises the substitutional solid metal oxide solution (M_{X}Zn_{Y}O) in an amount in the range of from about 5 to about 70 weight percent based on the total weight of the washcoat, more preferably in the range of from about 15 to about 60 weight percent, and most preferably in the range of from 20 to 40 weight percent.

Substitutional solid solutions have unique physical and chemical properties that are important to the chemistry of the monolith sorbent composition described herein. Substitutional solid solutions are a subset of alloys that are formed by the direct substitution of the solute metal for the solvent metal atoms in the crystal structure. For example, it is believed that the substitutional solid metal oxide solution (M_{X}Zn_{Y}O) found in the oxidized (i.e., unreduced) monolith sorbent composition made by the process of the present invention is formed by the solute zinc metal atoms substituting for the solvent promoter metal atoms. There are three basic criteria that favor the formation of substitutional solid solutions: (1) the atomic radii of the two elements are within 15 percent of each other; (2) the crystal structures of the two pure phases are the same; and (3) the electronegativities of the two components are similar. The promoter metal (as the elemental metal or metal oxide) and zinc oxide employed in the inventive sorbent composition preferably meet at least two of the three criteria set forth above. For example, when the promoter metal is nickel, the first and third criteria, are met, but the second is not. The nickel and zinc metal atomic radii are within 10 percent of each other and the electronegativities are similar. However, nickel oxide (NiO) preferentially forms a cubic crystal structure, while zinc oxide (ZnO) prefers a hexagonal crystal structure. A nickel zinc oxide solid solution retains the cubic structure of the nickel oxide. Forcing the zinc oxide to reside in the cubic structure increases the energy of the phase, which limits the amount of zinc that can be dissolved in the nickel oxide structure. This stoichiometry control manifests itself microscopically in a 70:30 nickel zinc oxide solid solution (Ni_{0.7}Zn_{0.3}O) that is formed during oxidation (i.e., calcination or regeneration) and microscopically in the repeated regenerability of the sorbent.

During calcination of the promoted washcoated substrate, at least a portion of the promoter metal combines with at least a portion of the zinc aluminate to form a promoter metal-zinc aluminate substitutional solid solution characterized by the formula: M_{z}Zn_{(l-z)}Al₂O₄), wherein M is the promoter and Z is a numerical value in the range of from 0.01 to 0.99. The washcoat of the unreduced monolith sorbent preferably comprises the promoter metal-zinc aluminate substitutional solid solution in an amount in the range of from about 1 to about 50 weight percent based on the total weight of the washcoat, more preferably in the range of from about 5 to about 30 weight percent, and most preferably in the range of from about 10 to 20 weight percent.

The washcoat of the unreduced monolith sorbent preferably comprises zinc oxide in an amount in the range of from about 5 to about 80 weight percent based on the total weight of the washcoat, more preferably in the range of from about 20 to about 60 weight percent, and most preferably in the range of from about 30 to 50 weight percent.

After calcination, the unreduced monolith sorbent is thereafter subjected to reduction with a suitable reducing agent, preferably hydrogen, under reducing conditions, to thereby provide a reduced monolith sorbent composition. Reduction can be carried out at a temperature in the range of from about 100° F. to about 1500° F. and a pressure in the range of from about 15 psia to about 1500 psia. Such reduction can be carried out for a time period sufficient to achieve the desired level of reduction, generally a time period in the range of from about 0.1 hour to about 20 hours.

The reduced monolith sorbent comprises a reduced-valence promoter metal component. The valence of the reduced-valence promoter metal component of the reduced monolith sorbent is less than the valence of the unreduced promoter metal component present in the unreduced monolith sorbent. The reduced-valence promoter metal component comprises, consists of, or consists essentially of a substitutional solid metal solution characterized by the formula: M_{A}Zn_{B}, wherein M is the promoter metal and A and B are each numerical values in the range of from 0.01 to 0.99. In the above formula for the substitutional solid metal solution, it is preferred for A to be in the range of from about 0.70 to about 0.97, and most preferably in the range of from about 0.85 to about 0.95. It is further preferred for B to be in the range of from about 0.03 to about 0.30, and most preferably in the range of from about 0.05 to 0.15. Preferably, B is equal to (1-A). During reduction of the unreduced monolith sorbent, at least a portion of the substitutional solid metal oxide solution (M_{X}Zn_{Y}O) is preferably reduced to form the substitutional solid metal solution (M_{A}Zn_{B}). The washcoat of the reduced monolith sorbent preferably comprises the substitutional solid metal solution (M_{A}Zn_{B}) in an amount in the range of from about 4 to about 60 weight percent based on the total weight of the washcoat, more preferably in the range of from about 10 to about 50 weight percent, and most preferably in the range of from about 15 to 30 weight percent.

The washcoat of the reduced monolith sorbent preferably comprises the promoter metal-zinc aluminate substitutional solid solution (M_{z}Zn_{(1-z)}Al₂O₄), described above with reference to the unreduced monolith sorbent, in an amount in the range of from about 1 to about 50 weight percent based on the total weight of the washcoat, more preferably in the range of from about 5 to about 30 weight percent, and most preferably in the range of from 10 to 20 weight percent.

The washcoat of the reduced sorbent preferably comprises zinc oxide in an amount in the range of from about 5 to about 80 weight percent based on the total weight of the washcoat, more preferably in the range of from about 20 to about 60 weight percent, and most preferably in the range of from 30 to 50 weight percent.

The weight ratio of zinc oxide to the reduced-valence promoter metal component in the washcoat of the reduced monolith sorbent is preferably in the range of from about 0.2:1 to about 15:1, more preferably in the range of from about 0.5:1 to about 8:1, and most preferably in the range of from 0.75:1 to 3:1. The weight ratio of zinc oxide to the promoter metal-zinc aluminate substitutional solid solution (M_{z}Zn_{(1-z)}Al₂O₄) in the washcoat of the reduced monolith sorbent is preferably in the range of from about 0.5:1 to about 30: 1, more preferably in the range of from about 1:1 to about 10: 1, and most preferably in the range of from 2:1 to 5:1.

In accordance with a second embodiment of the present invention a reduced monolith sorbent composition is provided. The reduced monolith sorbent of the second embodiment of the present invention is preferably made by the process of the first embodiment of the present invention and has the same components in the same amounts as the reduced monolith sorbent described above in the first embodiment of the present invention.

In accordance with a third embodiment of the present invention, the reduced monolith sorbent composition of the second embodiment of the present invention can be contacted with a sulfur-containing fluid in a desulfurization zone, to thereby form a desulfurized fluid and a sulfided monolith sorbent.

The sulfur-containing fluid employed in the desulfurization process of the present invention is preferably a hydrocarbon-containing fluid comprising a quantity of sulfur compounds therein. Preferably, such hydrocarbon-containing fluid can be used as a fuel or can be a precursor to fuel. Examples of suitable hydrocarbon-containing fluids include cracked-gasoline, diesel fuels, jet fuels, straight-run naphtha, straight-run distillates, coker gas oil, coker naphtha, alkylates, and straight-run gas oil. Most preferably, the sulfur-containing fluid comprises a hydrocarbon-containing fluid selected from the group consisting of gasoline, cracked-gasoline, diesel fuel, and mixtures thereof.

As used herein, the term “gasoline” denotes a mixture of hydrocarbons boiling in a range of from about 100° F. to about 400° F., or any fraction thereof. Examples of suitable gasolines include, but are not limited to, hydrocarbon streams in refineries such as naphtha, straight-run naphtha, coker naphtha, catalytic gasoline, visbreaker naphtha, alkylates, isomerate, reformate, and the like, and mixtures thereof.

As used herein, the term “cracked-gasoline” denotes a mixture of hydrocarbons boiling in a range of from about 100° F. to about 400° F., or any fraction thereof, that are products of either thermal or catalytic processes that crack larger hydrocarbon molecules into smaller molecules. Examples of suitable thermal processes include, but are not limited to, coking, thermal cracking, visbreaking, and the like, and combinations thereof. Examples of suitable catalytic cracking processes include, but are not limited to, fluid catalytic cracking, heavy oil cracking, and the like, and combinations thereof. Thus, examples of suitable cracked-gasolines include, but are not limited to, coker gasoline, thermally cracked gasoline, visbreaker gasoline, fluid catalytically cracked gasoline, heavy oil cracked-gasoline and the like, and combinations thereof. In some instances, the cracked-gasoline may be fractionated and/or hydrotreated prior to desulfurization when used as the sulfur-containing fluid in the process in the present invention.

As used herein, the term “diesel fuel” denotes a mixture of hydrocarbons boiling in a range of from about 300° F. to about 750° F., or any fraction thereof. Examples of suitable diesel fuels include, but are not limited to, light cycle oil, kerosene, jet fuel, straight-run diesel, hydrotreated diesel, and the like, and combinations thereof.

The sulfur-containing fluid described herein as suitable feed in the inventive desulfurization process comprises a quantity of olefins, aromatics, and sulfur, as well as paraffins and naphthenes. The amount of olefins in gaseous cracked-gasoline is generally in a range of from about 10 to about 35 weight percent olefins based on the total weight of the gaseous cracked-gasoline. For diesel fuel there is essentially no olefin content. The amount of aromatics in gaseous cracked-gasoline is generally in a range of from about 20 to about 40 weight percent aromatics based on the total weight of the gaseous cracked-gasoline. The amount of aromatics in gaseous diesel fuel is generally in a range of from about 10 to about 90 weight percent aromatics based on the total weight of the gaseous diesel fuel. The amount of atomic sulfur in the sulfur-containing fluid, preferably cracked-gasoline or diesel fuel, suitable for use in the inventive desulfurization process is generally greater than about 50 parts per million by weight (ppmw) of the sulfur-containing fluid, more preferably in a range of from about 100 ppmw atomic sulfur to about 10,000 ppmw atomic sulfur, and most preferably from 150 ppmw atomic sulfur to 500 ppmw atomic sulfur. It is preferred for at least about 50 weight percent of the atomic sulfur present in the sulfur-containing fluid employed in the present invention to be in the form of organosulfur compounds. More preferably, at least about 75 weight percent of the atomic sulfur present in the sulfur-containing fluid is in the form of organosulfur compounds, and most preferably at least 90 weight percent of the atomic sulfur is in the form of organosulfur compounds. As used herein, “sulfur” used in conjunction with “ppmw sulfur” or the term “atomic sulfur”, denotes the amount of atomic sulfur (about 32 atomic mass units) in the sulfur-containing fluid, not the atomic mass, or weight, of a sulfur compound, such as an organo-sulfur compound.

As used herein, the term “sulfur” denotes sulfur in any form normally present in a sulfur-containing fluid such as cracked-gasoline or diesel fuel. Examples of such sulfur which can be removed from a sulfur-containing fluid through the practice of the present invention include, but are not limited to, hydrogen sulfide, carbonal sulfide (COS), carbon disulfide (CS₂), mercaptans (RSH), organic sulfides (R-S-R), organic disulfides (R-S-S-R), thiophene, substitute thiophenes, organic trisulfides, organic tetrasulfides, benzothiophene, alkyl thiophenes, alkyl benzothiophenes, alkyl dibenzothiophenes, and the like, and combinations thereof, as well as heavier molecular weights of the same which are normally present in sulfur-containing fluids of the types contemplated for use in the desulfurization process of the present invention, wherein each R can by an alkyl, cycloalkyl, or aryl group containing 1 to 10 carbon atoms.

As used herein, the term “fluid” denotes gas, liquid, vapor, and combinations thereof.

As used herein, the term “gaseous” denotes the state in which the sulfur-containing fluid, such as cracked-gasoline or diesel fuel, is primarily in a gas or vapor phase.

The contacting of the sulfur-containing fluid and reduced monolith sorbent composition is carried out in a reaction zone of a monolith fixed bed reactor by passing the sulfur-containing fluid through the channels of the reduced monolith sorbent under a set of desulfurization conditions that include total pressure, temperature, and weighted hourly space velocity. The desulfurization conditions at which the reaction zone is maintained during desulfurization preferably include a temperature in a range of from about 200° F. to about 1200° F., more preferably from about 500° F. to about 900° F., and most preferably from 600° F. to 800° F. for best sulfur removal. The total pressure at which the reaction zone is maintained during desulfurization is preferably in a range of from about 15 pounds per square inch gauge (psig) to about 1500 psig, more preferably from about 50 psig to about 600 psig, and most preferably from 100 psig to 200 psig for best sulfur removal. As used herein, the term “weighted hourly spaced velocity” or “WHSV” is defined as the numerical ratio of the rate at which the sulfur-containing fluid is charged to the reaction zone in pounds per hour at standard conditions of temperature and pressure (STP) divided by the pounds of the sorbent composition contained in the reaction zone to which the sulfur-containing fluid is charged. In the practice of the present invention, such WHSV should be in a range of about 0.5 hr⁻¹ to about 50 hr⁻¹, preferably in a range of from about 1 hr⁻¹ to about 20 hr⁻¹ for best sulfur removal. Desulfurization of the sulfur-containing fluid in the reaction zone should be conducted for a time sufficient to affect the removal of at least a substantial portion of the sulfur from such sulfur-containing fluid.

During desulfurization, a hydrogen-containing co-feed gas is simultaneously charged to the reaction zone with the sulfur-containing fluid. The co-feed gas provides a source of hydrogen for the hydrogen-consuming reactions taking place in the reaction zone during desulfurization of the sulfur-containing fluid. The co-feed gas is preferably mixed with the sulfur-containing fluid prior to injection into the reaction zone. The co-feed gas preferably comprises from 80 to about 100 volume percent hydrogen, more preferably from about 85 to about 95 volume percent hydrogen, and most preferably from 88 to 92 volume percent hydrogen. The remaining (non-hydrogen) volume of the co-feed gas is preferably a gaseous diluent which is substantially inert to the desulfurization reactions taking place in the reaction zone. Preferably, such diluent is nitrogen. The co-feed gas preferably comprises from about 0 to about 20 volume percent of the diluent, more preferably from about 5 to about 15 volume percent of the diluent, and most preferably from 8 to 12 volume percent of the diluent. The amount of co-feed gas charged to the reaction zone is preferably an amount which provides a molar ratio of hydrogen to sulfur-containing fluid in a range of from about 0.1:1 to about 10: 1, more preferably in the range of from 0.5:1 to 3:1.

It is presently preferred that the desulfurization reaction of the present invention is carried out in the reaction zone of a monolith fixed bed reactor. As used herein, the term “monolith fixed bed reactor” denotes a reactor wherein a fluid feed charged to the reactor is passed through a plurality of channels in a multicellular monolith catalyst/sorbent. While passing through the channels of the catalyst/sorbent, the fluid feed is contacted with the catalyst/sorbent to thereby induce the desired reaction.

When the reduced monolith sorbent composition is contacted with the sulfur-containing fluid in the reaction zone under desulfurization conditions, sulfur compounds, particularly organosulfur compounds, present in the sulfur-containing fluid are removed from such fluid. At least a portion of the sulfur removed from the sulfur-containing fluid is employed to convert at least a portion of the zinc oxide of the sorbent composition into zinc sulfide. While not wishing to be bound by theory, it is believed that the reduced-valence promoter metal component of the reduced monolith sorbent functions to facilitate removal of the sulfur from the sulfur-containing fluid while the zinc oxide functions to facilitate the storage of the sulfur on/in the monolith sorbent through the conversion of at least a portion of the zinc oxide to zinc sulfide.

In contrast to many conventional sulfur removal processes (e.g., hydrodesulfurization), it is preferred that substantially none of the sulfur in the sulfur-containing fluid is converted to, and remains as, hydrogen sulfide during desulfurization in the reaction zone. Rather, it is preferred that the fluid effluent from the reaction zone (comprising all the fluids exiting the reaction zone) comprises less than about 200 percent (by weight) of the amount of hydrogen sulfide in the fluid feed charged to the desulfurization zone (comprising all the fluids entering the reaction zone), more preferably less than about 150 percent of the amount of hydrogen sulfide in the fluid feed, and most preferably less hydrogen sulfide than the fluid feed. The fluid effluent from the reaction zone preferably contains less than about 50 weight percent of the amount of sulfur in the fluid feed charged to the reaction zone, more preferably less than about 20 weight percent of the amount of sulfur in the fluid feed, and most preferably less than 5 weight percent of the amount of sulfur in the fluid feed. It is preferred for the total sulfur content of the fluid effluent from the reaction zone to be less than about 50 parts per million by weight (ppmw) of the total fluid effluent, more preferably less than about 30 ppmw, still more preferably less than about 15 ppmw, and most preferably less than 10 ppmw.

The desulfurized fluid, preferably desulfurized cracked-gasoline or desulfurized diesel fuel, can thereafter be recovered from the fluid effluent and preferably liquified. The liquification of such desulfurized fluid can be accomplished by any method or manner known in the art. The liquified, desulfurized fluid preferably comprises less than about 50 weight percent of the amount of sulfur in the sulfur-containing fluid charged to the reaction zone, more preferably less than about 20 weight percent of the amount of sulfur in the sulfur-containing fluid, and most preferably less than 5 weight percent of the amount of sulfur in the sulfur-containing fluid. The desulfurized fluid preferably comprises less than about 50 ppmw sulfur, more preferably less than about 30 ppmw sulfur, still more preferably less than about 15 ppmw sulfur, and most preferably less than 10 ppmw sulfur.

After desulfurization has caused at least partial deactivation of the monolith sorbent, the sulfided monolith sorbent is preferably regenerated in the reaction zone by contacting the sulfided sorbent with an oxygen-containing regeneration stream under suitable regeneration conditions. The regeneration is preferably carried out at a temperature in a range of from about 200° F. to about 1500° F., more preferably from about 500° F. to about 1200° F., and most preferably from 800° F. to 1100° F. The total pressure in the reaction zone during regeneration is preferably maintained in a range of from about 10 psig to about 1500 psig, more preferably in a range of from 15 psig to 100 psig. The regeneration time of the sorbent can be any time sufficient to achieve the desired level of sorbent regeneration. Such regeneration time is preferably in a range of from about 0.1 hours to about 24 hours, more preferably from 0.5 hours to 3 hours. These parameters provide for best sorbent regeneration.

The oxygen-containing regeneration stream employed in the regeneration step can be any oxygen-containing stream that, when contacted with the sulfided monolith sorbent under the above-described regeneration conditions, promotes the conversion of at least a portion of the zinc sulfide associated with the sulfided sorbent to zinc oxide, promotes the conversion of at least a portion of the substitutional solid metal solution (M_{A}Zn_{B}) and/or sulfided substitutional solid metal solution (M_{A}Zn_{B}S) to the substitutional solid metal oxide solution (M_{X}Zn_{Y}O) and bums off any remaining hydrocarbon deposits that might be present on the sulfided monolith sorbent.

After regeneration, the desulfurized (i.e., unreduced) monolith sorbent is subjected to reduction (i.e., activation) in the reaction zone under activation conditions with a reducing stream, preferably a hydrogen-containing reducing stream, so that the valence of at least a portion of the unreduced promoter metal component (i.e., the substitutional solid metal oxide solution (M_{X}Zn_{Y}O)) is reduced to form the reduced-valence promoter metal component (i.e., the substitutional solid metal solution (M_{A}Zn_{B})), thereby providing a reduced monolith sorbent. Such reduced-valence promoter metal component is present in the reduced monolith sorbent in an amount which provides for the removal of sulfur from a sulfur-containing fluid according to the process of the present invention.

Typical activation conditions include a temperature in a range of from about 100° F. to about 1500° F., more preferably from about 500° F. to about 900° F., and most preferably from 600° F. to 800° F. The activation pressure is preferably in a range of from about 10 psig to about 1500 psig, more preferably from 15 psig to 100 psig. The activation time of the monolith sorbent is preferably in a range of from about 0.1 hours to about 40 hours, more preferably from about 0.2 hours to about 10 hours, and most preferably from about 0.5 hours to 1 hour. The reducing stream with which the monolith sorbent is contacted in the reaction zone preferably contains at least about 25 volume percent hydrogen, more preferably at least about 50 volume percent hydrogen, still more preferably at least about 90 volume percent hydrogen, and most preferably at least 95 volume percent hydrogen. Thus, it is not essential to the practice of the present invention that a high purity hydrogen be employed in achieving the desired reduction (i.e., activation) of the sorbent composition. Conditions recited in this paragraph provide for best activation of the unreduced monolith sorbent.

Once the sorbent has been activated in the reaction zone, the reduced monolith sorbent can once-again be contacted the sulfur-containing fluid to remove sulfur therefrom.

The following examples are presented to further illustrate this invention and are not to be construed as unduly limiting the scope of this invention.

### EXAMPLE I

Three monolith sorbents were prepared by coating three individual multicellular substrates with a washcoat and then impregnating the washcoated substrate with nickel.

The initial multicellular substrates were inert, cordierite-based, one inch substrates comprising 100 cells per inch (available from Corning Glass Works, Coming, N.Y.). A washcoat slurry was prepared by mixing aluminum hydroxide powder (Dispal® Alumina Powder, available from CONDEA Vista Company, Houston, Tex.), zinc oxide powder (available from Zinc Corporation, Monaco, Pa.), diatomaceous earth (Celite® Filter Cel, available from Manville Sales Corporation, Lompoc, Calif.), distilled water, and a dispersant (Darvan® 821A, available from R. T. Vanderbilt Company, Inc., Norwalk, Conn.). The washcoat slurry contained 40 weight percent solids (i.e., aluminum hydroxide, zinc oxide, and diatomaceous earth) and 60 weight percent liquids (i.e., water and dispersant). The amounts of the aluminum hydroxide, zinc oxide, and diatomaceous earth in the washcoat slurry were 10, 50, and 40 weight percent, respectively, based on the total weight of the solids in the washcoat slurry. About 2.5 grams of the dispersant was added for each 100 grams of solids. The ingredients of the washcoat slurry were mixed until a homogenous washcoat slurry was obtained.

Each of the substrates were then coated with the washcoat slurry by individually dipping the substrates into the washcoat slurry. The washcoated substrates were then dried at about 150° C. for about 2 hours and then calcined at about 635° C. for about 1 hour.

The resulting calcined washcoated substrates were then individually impregnated with nickel by dipping the calcined washcoated substrates in an impregnation solution. In a typical experiment a calcined washcoated substrate containing 4.26 grams of washcoat was impregnated by dipping the substrate in an impregnation solution containing 2.72 grams of nickel nitrate hexahudrate and 2.0 grams of water. The dipping was accomplished by contacting the calcined washcoated substrate with the impregnation solution for 1 minute, then removing the calcined washcoated substrate from the solution, turning it upside down, and recontacting it with the impregnation solution until substantially all of the impregnation solution was absorbed by the calcined washcoated substrate. After impregnation, the promoted washcoated substrates were placed in an oven and dried at 100° C. for 1 hour. The oven temperature was then ramped at 3° C./min to 150° C. and held at 150° C. for 1 hour. The oven temperature was then ramped at 5° C./min to 635° C. and held at 635° C. for 1 hour to thereby calcine the promoted washcoated substrates and provide unreduced monolith sorbents. Each of the unreduced monolith sorbents contained about 13.8 weight percent nickel.

### EXAMPLE II

The three unreduced monolith sorbents produced in Example I were loaded into a reactor, reduced, and tested for desulfurization activity.

The three unreduced monolith sorbents were loaded in a 1″ I.D. quartz reactor tube in a manner such that the monoliths were stacked in series. The unreduced monolith sorbents were then reduced by charging hydrogen to the reactor at 300 sccm at 750° F. for 1 hour. After reduction with hydrogen, a catalytically-cracked gasoline feed (340 ppmw sulfur and 20 wt % olefins) was charged to the reactor tube and passed through the channels of the reduced monolith sorbents. The cracked-gasoline was charged at a rate of 1 WHSV while the reactor was maintained at a temperature of about 750° F. Hydrogen and nitrogen were co-fed to the reactor with the gasoline at a rate in the range from about 80 sccm to about 100 sccm each. Samples of the desulfurized effluent were taken at 2, 3, and 4 hours on stream. These samples were then analyzed by x-ray fluorescence to determine the amount of sulfur in the reactor effluent.

After 4 hours on stream (i.e., one cycle) the flow of the cracked-gasoline feed was terminated and the sulfided monolith sorbents were regenerated with a 4 percent oxygen in nitrogen stream flowing at 300 sccm at a temperature of 1,000° F. for 1 hour. The regenerated, unreduced monolith sorbents were then reduced with hydrogen in substantially the same manner as described above. The reduced monolith sorbent was then subjected to 3 more cycles of desulfurization, regeneration, and reduction.

Table 1 summarizes the results from the reactor testing of the monolith sorbents prepared in Example I.

TABLE 1

| | Sulfur in Reactor Effluent (ppmw) | | |
|---|---|---|---|
| Cycle | 2 Hours on Stream | 3 Hours on Stream | 4 Hours on Stream |
| 1 | 2.8 | 2.4 | 3.1 |
| 2 | 8.5 | 8.7 | 12.8 |
| 3 | 9.1 | 13.3 | 21.3 |
| 4 | 10.9 | 24.0 | 32.0 |

Table 1 shows that a reduced, nickel-impregnated zinc oxide-containing, monolith sorbent is very effective for removing sulfur from cracked-gasoline.

Reasonable variations, modifications, and adaptations can be made within the scope of this disclosure and the appended claims without departing from the scope of this invention.

That which is claimed is:

1. A reduced monolith sorbent comprising:
a multicellular body defining a plurality coextensive open-ended channels and comprising a reduced-valence promoter metal component and zinc oxide.

2. A monolith sorbent in accordance with claim 1, wherein the weight ratio of said zinc oxide to said reduced-valence promoter metal component is in the range of from about 0.2:1 to about 15:1.

3. A monolith sorbent in accordance with claim 1, wherein the weight ratio of said zinc oxide to said reduced-valence promoter component is in the range of from about 0.5:1 to about 2:1.

4. A monolith sorbent in accordance with claim 1, wherein said reduced-valence promoter component comprises a metal selected from a group consisting of nickel, cobalt, iron, manganese, tungsten, silver, gold, copper, platinum, zinc, tin, ruthenium, molybdenum, antimony, vanadium, iridium, chromium, palladium, and rhodium.

5. A monolith sorbent in accordance with claim 1, wherein said reduced-valence promoter metal component comprises nickel.

6. A monolith sorbent in accordance with claim 1, wherein said reduced-valence promoter metal comprises a substitutional solid metal solution characterized by the formula M_{A}Zn_{B}, wherein M is a promoter metal selected from a group consisting of nickel, cobalt, iron, manganese, tungsten, silver, gold, copper, platinum, zinc, tin, ruthenium, molybdenum, antimony, vanadium, iridium, chromium, palladium, and rhodium, and wherein A and B are each numerical values in the range of from 0.01 to 0.99.

7. A monolith sorbent in accordance with claim 6, wherein said promoter metal is nickel.

8. A monolith sorbent according to claim 7, wherein A is in the range of from about 0.70 to about 0.97 and B is in the range of from about 0.03 to about 0.30.

9. A monolith sorbent according to claim 1, wherein said body comprises cordierite.

10. A monolith sorbent in accordance with claim 1, wherein said channels extend substantially parallel to one another.

11. A monolith sorbent in accordance with claim 10, wherein said body comprises in the range of from about 10 to about 500 of said channels per square inch.

12. A monolith sorbent in accordance with claim 1, wherein said body includes a multicellular ceramic substrate and a washcoat covering said substrate, wherein said washcoat comprises said reduced-valence promoter metal component and said zinc oxide.

13. A monolith sorbent according to claim 12, wherein said washcoat further comprises an aluminate.

14. A monolith sorbent in accordance with claim 13, wherein said washcoat further comprises silica.

15. A monolith sorbent in accordance with claim 12, wherein said washcoat comprises within the range of about 5 to about 80 weight percent of said reduced-valence promoter metal component and in the range of from about 5 to about 80 weight percent of said zinc oxide.

16. A monolith sorbent in accordance with claim 12, wherein said reduced-valence promoter metal comprises a substitutional solid metal solution characterized by the formula M_{A}Zn_{B}, wherein M is a promoter metal selected from a group consisting of nickel, cobalt, iron, manganese, tungsten, silver, gold, copper, platinum, zinc, tin, ruthenium, molybdenum, antimony, vanadium, iridium, chromium, palladium, and rhodium, and wherein A and B are each numerical values in the range of from 0.01 to 0.99.

17. A monolith sorbent in accordance with claim 16, wherein said promoter metal is nickel.

18. A monolith sorbent in accordance with claim 17, wherein A is in the range of from about 0.70 to about 0.97 and B is in the range of from about 0.03 to about 0.30.

19. A process for preparing a monolith sorbent, said process comprising the steps of:
(a) providing a multicellular substrate defining a plurality of coextensive open-ended substrate channels;
(b) coating said substrate with a washcoat slurry comprising zinc oxide to provide a washcoated substrate;
(c) incorporating a promoter metal with said washcoated substrate to provide a promoted washcoated substrate;
(d) calcining said promoted washcoated substrate to provide an unreduced monolith sorbent; and
(e) reducing said unreduced monolith sorbent to thereby provide a reduced monolith sorbent comprising a reduced-valence promoter metal component and zinc oxide.

20. A process in accordance with claim 19, wherein said multicellular substrate defines in the range of from about 10 to about 200 of said substrate channels per square inch, wherein said substrate channels extend substantially parallel to one another.

21. A process in accordance with claim 20, wherein said substrate comprises cordierite.

22. A process in accordance with claim 19, wherein said washcoat slurry further comprises alumina and silica.

23. A process in accordance with claim 19, wherein said washcoat slurry comprises washcoat solid components and washcoat liquid components, wherein the weight ratio of said washcoat solid components to said washcoat liquid components is in the range of from about 0.2:1 to about 10: 1, wherein said washcoat solid components comprise from about 20 to about 90 weight percent zinc oxide.

24. A process in accordance with claim 19, wherein said promoter metal is selected from the group consisting of nickel, cobalt, iron, manganese, tungsten, silver, gold, copper, platinum, zinc, tin, ruthenium, molybdenum, antimony, vanadium, iridium, chromium, palladium, and rhodium.

25. A process in accordance with claim 19, wherein said promoter metal is nickel.

26. A process in accordance with claim 19, wherein said incorporating is accomplished by impregnating said washcoated substrate using an aqueous solution comprising said promoter metal.

27. A process in accordance with claim 19, wherein said coating is accomplished by dipping said multicellular substrate in said washcoat slurry.

28. A process in accordance with claim 19, wherein said reduced-valence promoter metal comprises a substitutional solid metal solution characterized by the formula M_{A}Zn_{B}, wherein M is said promoter metal, and wherein A and B are each numerical values in the range of from 0.01 to 0.99.

29. A process in accordance with claim 28, wherein said promoter metal is nickel.

30. A process in accordance with claim 29, wherein A is in the range of from about 0.70 to about 0.97 and B is in the range of from about 0.03 to about 0.30.

31. A process in accordance with claim 19, wherein said unreduced monolith sorbent comprises an unreduced promoter metal component, wherein said unreduced promoter metal component comprises a substitutional solid metal oxide solution characterized by the formula M_{X}Zn_{Y}O, wherein M is said promoter metal, and wherein X and Y are each numerical values in the range of from 0.01 to 0.99.

32. A process in accordance with claim 31, wherein said promoter metal is nickel.

33. A process in accordance with claim 19, wherein said calcining is performed at a temperature in the range of from about 400° F. to about 1800° F., and wherein said reducing is performed at a temperature in the range of from about 100° F. to about 1500° F.

34. A process in accordance with claim 19, wherein said washcoated substrate is calcined prior to being incorporated with said promoter metal.

35. A monolith sorbent prepared by the process of claim 19.

36. A desulfurization process comprising the steps of:
(a) passing a sulfur-containing fluid through a monolith sorbent comprising a reduced-valence promoter metal component and zinc oxide under desulfurization conditions sufficient to convert at least a portion of said zinc oxide to zinc sulfide, thereby providing a sulfided monolith sorbent and a desulfurized fluid;
(b) passing an oxygen-containing regeneration stream through said sulfided monolith sorbent under regeneration conditions sufficient to convert at least a portion of said zinc sulfide to zinc oxide, thereby providing an unreduced monolith sorbent comprising an unreduced promoter metal component; and
(c) passing a hydrogen-containing reducing stream through said unreduced monolith sorbent under activation conditions sufficient to reduce the valence of said unreduced promoter metal component, thereby providing a reduced monolith sorbent comprising said reduced-valence promoter metal component and said zinc oxide.

37. A process in accordance with claim 36, further including the step of:
(d) passing said sulfur-containing fluid through said reduced monolith sorbent.

38. A desulfurization process in accordance with claim 36, wherein said desulfurized fluid contains less than about 50 weight percent of the amount of sulfur in said sulfur-containing fluid.

39. A desulfurization process in accordance with claim 36, wherein said sulfur-containing fluid is a fluid selected from a group consisting of cracked-gasoline, diesel fuel, gasoline, and mixtures thereof.

40. A desulfurization process in accordance with claim 36, wherein said desulfurization conditions include a temperature in the range of from about 200° F. to about 1200° F., wherein said regeneration conditions include a temperature in the range of from about 200° F. to about 1500° F., and wherein said activation conditions include a temperature in the range of from about 100° F. to about 1500° F.

41. A desulfurization process in accordance with claim 36, wherein the weight ratio of said zinc oxide to said reduced-valence promoter metal component in said reduced monolith sorbent is in the range of from about 0.2:1 to about 10:1.

42. A desulfurization process in accordance with claim 36, wherein said unreduced promoter metal component comprises a substitutional solid metal oxide solution characterized by the formula M_{X}Zn_{Y}O, wherein M is a promoter metal selected from the group consisting of nickel, cobalt, iron, manganese, tungsten, silver, gold, copper, platinum, zinc, tin, ruthenium, molybdenum, antimony, vanadium, iridium, chromium, palladium, and rhodium, and wherein X and Y are each numerical values in the range of from 0.01 to 0.99.

43. A desulfurization process in accordance with claim 42, wherein said reduced-valence promoter metal component comprises a substitutional solid metal solution characterized by the formula M_{A}Zn_{B}, wherein M is a promoter metal selected from a group consisting of nickel, cobalt, iron, manganese, tungsten, silver, gold, copper, platinum, zinc, tin, ruthenium, molybdenum, antimony, vanadium, iridium, chromium, palladium, and rhodium, and wherein A and B are each numerical values in the range of from 0.01 to 0.99.

44. A desulfurization process in accordance with claim 36, wherein said reduced monolith sorbent comprises a multicellular ceramic substrate coated with a washcoat, wherein said washcoat comprises said reduced-valence promoter metal component and said zinc oxide.

45. A desulfurization process in accordance with claim 44, wherein said washcoat comprises said reduced-valence promoter component in an amount in the range of from about 5 to about 80 weight percent, and wherein said washcoat comprises said zinc oxide in an amount in the range of from about 5 to about 80 weight percent.

46. A desulfurization process in accordance with claim 45, wherein said washcoat further comprises an aluminate, and wherein said substrate comprises cordierite.

47. A desulfurization process in accordance with claim 36, wherein said reduced monolith sorbent defines a plurality of open ended channels extending therethrough, wherein said reduced monolith sorbent comprises in the range of from about 10 to about 1500 of said channels per square inch, and wherein said channels extend substantially parallel to one another.
